(19) United States
(12) Patent Application Publication
(10) Pub. No.: US 2014/0152139 A1
(43) Pub. Date: Jun. 5, 2014

(54) PERMANENT MAGNET SYNCHRONOUS MOTOR

(71) Applicants: Hui Huang, Zhuhai (CN); Yusheng Hu, Zhuhai (CN); Dongsuo Chen, Zhuhai (CN); Huajie Chen, Zhuhai (CN); Yong Xiao, Zhuhai (CN); Xueying Zeng, Zhuhai (CN); Wenming Zhang, Zhuhai (CN)

(72) Inventors: Hui Huang, Zhuhai (CN); Yusheng Hu, Zhuhai (CN); Dongsuo Chen, Zhuhai (CN); Huajie Chen, Zhuhai (CN); Yong Xiao, Zhuhai (CN); Xueying Zeng, Zhuhai (CN); Wenming Zhang, Zhuhai (CN)

(73) Assignees: Gree Green Refrigeration Technology Center Co., Ltd. of Zhuhai, Zhuhai, Guangdong (CN); Gree Electric Appliances, Inc. of Zhuhai, Zhuhai, Guangdong (CN)

(21) Appl. No.: 14/235,408

(22) PCT Filed: Aug. 31, 2011
(86) PCT No.: PCT/CN2011/079181

§ 371 Date: Jan. 27, 2014

(30) Foreign Application Priority Data
Jul. 28, 2011 (CN) 201110212590.0

(51) Int. Cl. H02K 1/27

(52) U.S. Cl. CPC H02K 1/2766
USPC 310/156.38

(57) ABSTRACT

Disclosed is a permanent magnet synchronous motor comprising a stator (1) and a rotor (2), wherein the stator (1) is provided thereon with a plurality of wire slots (3) in a circumferential direction, the rotor (2) is provided therein with a plurality of sets of magnet slots (5) in a circumferential direction, with the wire slots (3) being provided therein with coils (4) and the sets of magnet slots (5) being provided therein with permanent magnets (7); the number of poles of the permanent magnets (7) on the rotor (2) is P, the spacing between two adjacent sets of magnet slots (5) is W, the tooth width of the stator (1) is Lc, and the number of the wire slots (3) on the stator (1) is S, wherein 3PW/LcS=K, and 0.15≦K≦0.85. The permanent magnet synchronous motor can reduce dependence on rare earth and improve the output torque of the permanent magnet synchronous motor.

### TECHNICAL FIELD

The present application relates to a permanent magnet synchronous motor.

### BACKGROUND

A permanent magnet synchronous motor includes a stator and a rotor. Magnet slots are arranged in the rotor, and permanent magnets are provided inside the magnet slots. During the operation, the rotor is driven to run by a permanent magnet torque and a reluctance torque. An output torque of the permanent magnet synchronous motor is illustrated in the following formula:

T=mp(L_{q}−L_{d})i_{d}i_{q}+mpΨ_{PM}i_{q}

where, the first item in the formula, mp(L_{q}−L_{d})i_{d}i_{q}, is the reluctance torque; the second item in the formula, mpΨ_{PM}i_{q}, is the permanent magnet torque; Ψ_{PM} is a maximum value of stator-rotor coupling magnetic flux generated by permanent magnets; m is a phase number of a conductor of the stator; L_{d} and L_{q} are inductances along d-axis and q-axis respectively; and i_{d} and i_{q} are components of an armature current in the directions of d-axis and q-axis respectively.

Because the output torque T of the permanent magnet synchronous motor is affected by the permanent magnet torque greatly, in an existing method, the permanent magnet torque is increased by increasing the output torque T of the permanent magnet synchronous motor. It's seldom to increase the output torque T of the permanent magnet synchronous motor by improving the magnetic resistance torque.

In practice, the permanent magnet torque largely depends on the performance of the permanent magnets. Rare earth is applied to the existing process of manufacturing the permanent magnets. The usage of rare earth will cause the environment destruction and increase the producing cost, which is adverse to the optimal utilization of resource.

### SUMMARY

A permanent magnet synchronous motor is provided according to the disclosure, which can reduce the dependence on rare earth and increase the output torque of the permanent magnet synchronous motor on the other hand.

The technical solution of the disclosure is as follows.

A permanent magnet synchronous motor includes a stator and a rotor, wherein a plurality of wire slots are arranged in the stator along a circumferential direction of the stator, a plurality of magnet slot groups are arranged in the rotor along a circumferential direction of the rotor, wherein coils are provided in each of the wire slots and a permanent magnet is provided in each of magnet slot groups; the number of poles of the permanent magnets in the rotor is P, a distance between two adjacent magnet slot groups is W, a tooth width of the stator is Lc, and the number of the wire slots in the stator is S, wherein a parameter K of the permanent magnet synchronous motor satisfy an expression: 3PW/LcS=K, and 0.15≦K≦0.85.

Further, 0.2≦K≦0.8.

The wire slots are evenly distributed in the circumference direction of the stator and the magnet slot groups are evenly distributed in the circumference direction of the rotor.

The magnet slot group includes two magnet slots. The magnet slots of the magnet slot group have the same orientation and are arranged in a radial direction.

A cross section of the magnet slot is of arc-shaped or U-shaped slot, and an opening of the arc-shaped or U-shaped slot is towards a periphery of the stator in a radial direction of the magnet slot.

Clearances are respectively provided between two ends of the permanent magnet and the magnet slot.

The permanent magnet has a flat plate structure or an arc-shaped structure.

The permanent magnet has an arc-shaped structure, and a middle portion of the permanent magnet has a thickness greater than two ends of the permanent magnet.

The advantage or the principle of the disclosure is described hereinafter.

The disclosure differs with the traditional permanent magnet synchronous motor in that the output torque of the permanent magnet synchronous motor is improved from the view of magnet resistance torque. Specially, with the determined permanent magnets, the permanent magnet torque of the permanent magnet synchronous motor is a substantially constant. In this case, the output torque of the permanent magnet synchronous motor is improved by optimizing the structure of the permanent magnet synchronous motor. That is, without increasing the usage amount of rare earth, the output torque of the permanent magnet synchronous motor may be improved, the environment pollution may be reduced and the producing cost may be decreased.

It is proved by large number of experiments, that when 0.15≦K≦0.85, the value of Lq−Ld may be effectively improved, and then the output torque of the permanent magnet synchronous motor may be improved. When 0.2≦K≦0.8, the permanent magnet synchronous motor has a maximum value of the output torque.

Clearances are respectively provided between two ends of the permanent magnet and the magnetic slot, which can prevent the demagnetization of the ends of the permanent magnet and avoid an impact during the assemblage of the permanent magnet.

The middle portion of the permanent magnet has a thickness greater than two ends of the permanent magnet, which can not only prevent the demagnetization of the permanent magnet, but also avoid a sliding of the permanent magnet in the magnet slot.

### BRIEF DESCRIPTION OF THE DRAWINGS

FIG. 1 is a section view of a permanent magnet synchronous motor according to a first embodiment of this disclosure;

FIG. 2 is a partial enlarged view of the permanent magnet synchronous motor as shown in FIG. 1, in which coils and permanent magnets are removed;

FIG. 3 is a curve chart shown a relationship between a difference Lq−Ld of inductances along axis q and axis b and K;

FIG. 4 is a section view of a permanent magnet synchronous motor according to a second embodiment of this disclosure; and

FIG. 5 is a section view of a permanent magnet synchronous motor according to a third embodiment of this disclosure.

Reference numerals in the drawings:
1 stator, 2 rotor, 3 wire slot, 4 coil, 5 magnet slot group, 6 magnet slot, 7 permanent magnet, W distance, and Lc tooth width.

### DETAILED DESCRIPTION OF EMBODIMENTS

The embodiment of this disclosure is described in details hereinafter.

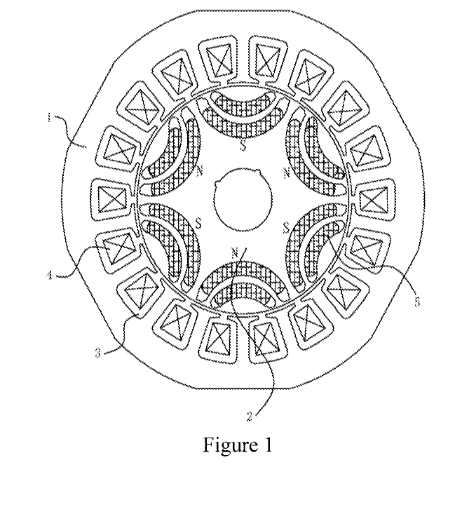

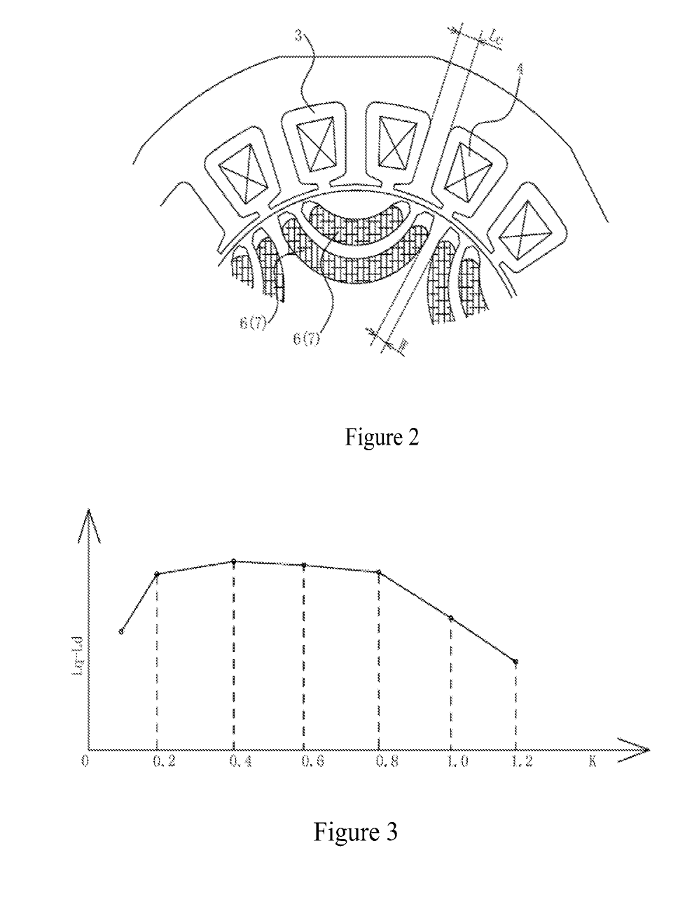

Referring to FIGS. 1 and 2, a permanent magnet synchronous motor according to a first embodiment includes a stator 1 and a rotor 2. Multiple wire slots 3 are arranged in the stator 1 along a circumferential direction of the stator. Multiple magnet slot groups 5 are arranged in the rotor along a circumferential direction of the rotor. Coils 4 are provided in each of the wire slots 3 and a permanent magnet 7 is provided in each of magnet slot groups 5. The number of poles of the permanent magnets 7 in the rotor 2 is P. A distance between two adjacent magnet slot groups 5 is W. A tooth width of the stator 1 is Lc. The number of the wire slots 3 in the stator 1 is S. A parameter K of the permanent magnet synchronous motor satisfy an expression: 3PW/LcS=K, and 0.15≦K≦0.85. Preferably, 0.2≦K≦0.8.

The permanent magnet 7 includes an N-pole permanent magnet and an S-pole permanent magnet. The polarities of permanent magnets 7 in a magnet slot group 5 are the same, and the polarities of permanent magnets 7 in adjacent magnet slot groups 5 are alternately arranged according to N-pole and S-pole. The wire slots 3 are evenly distributed in the circumference direction of the stator 3. The magnet slot groups 5 are evenly distributed in the circumference direction of the rotor 2. Each magnet slot group 5 includes two magnet slots 6, and magnet slots 6 of the magnet slot group 5 has the same orientation and are arranged in a radial direction. A cross section of the magnet slot 6 is of arc-shaped slot, and an opening of the arc-shaped slot is towards a periphery of the stator in a radial direction of the magnet slot. The permanent magnet 7 has an arc-shaped structure. Clearances are respectively provided between two ends of permanent magnet 7 and the magnet slot 6.

The advantage or the principle of the disclosure is described hereinafter.

The disclosure differs with the traditional permanent magnet synchronous motor in that the output torque of the permanent magnet synchronous motor is improved from the view of magnet resistance torque. Specially, with the determined permanent magnets 7, the permanent magnet torque of the permanent magnet synchronous motor is a substantially constant. In this case, the output torque of the permanent magnet synchronous motor is improved by optimizing the structure of the permanent magnet synchronous motor. That is, without increasing the usage amount of rare earth, the output torque of the permanent magnet synchronous motor may be improved, the environment pollution may be reduced and the producing cost may be decreased.

It is proved by large number of experiments according to the above solution that, when 0.15≦K≦0.85, the value of Lq−Ld may be effectively improved, and then the output torque of the permanent magnet synchronous motor may be improved. Preferably, 0.2≦K≦0.8. When K=0.4, the permanent magnet synchronous motor has a maximum value of the output torque, as shown in the FIG. 3.

Clearances are respectively provided between two ends of the permanent magnet 7 and the magnetic slot 6, which can prevent the demagnetization of the ends of the permanent magnet 7 and avoid an impact during the assemblage of the permanent magnet 7.

In the case of the determined permanent magnets, the permanent magnet torque of the permanent magnet synchronous motor is a substantially constant. With the solution of the disclosure, the value of the Lq−Ld may be increased by improving the structure of the permanent magnet synchronous motor. Then, the output torque of the permanent magnet synchronous motor may be improved based on the following expression. The usage of rare earth and the damage to environment can be reduced, and the producing cost can be decreased.

T=mp(L_{q}−L_{d})i_{d}i_{q}+mpΨ_{PM}i_{q}

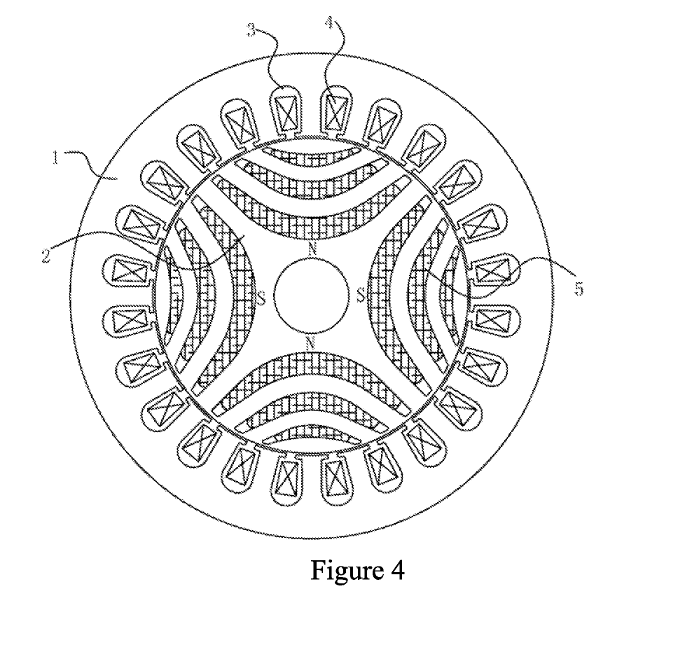

In a second embodiment, as shown in the FIG. 4, the magnet slot group 5 includes three magnet slots 6. A cross section of each magnet slot is of arc-shaped slot and an opening of the arc-shaped slot is towards a periphery of the stator in a radial direction of the magnet slot. The permanent magnet 7 has an arc-shaped structure, and a middle portion of the permanent magnet has a thickness greater than two ends of the permanent magnet. The principle of this embodiment is the same as that of the first embodiment. The middle portion of the permanent magnet has the thickness greater than two ends of the permanent magnet, which can not only prevent the demagnetization of the permanent magnets 7, but also avoid a sliding of the permanent magnet 7 in the magnet slot 6.

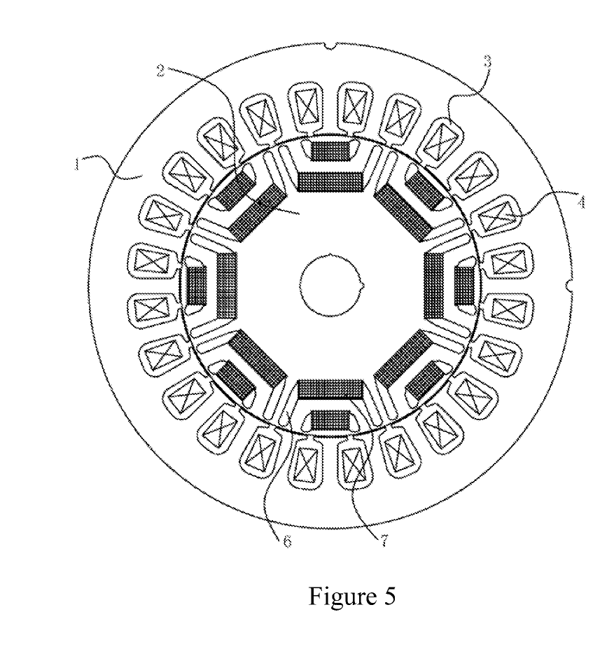

In a third embodiment, as shown in the FIG. 5, the magnet slot group 5 includes two magnet slots 6. A cross section of each magnet slot is of U-shaped slot and an opening of the arc-shaped slot is towards a periphery of the stator in a radial direction of the magnet slot. The permanent magnet 7 has a flat plate structure with a uniform thickness, which is located at a center of the magnet slot 6. The permanent magnet 7 with the flat plate structure has an easy manufacturing process. It's convenient for the magnetizing. Comparing with the permanent magnet with the arc-shaped structure, the permanent magnet 7 with the flat plate structure has a low cost. The principle of the embodiment is the same as that of the first embodiment, which is omitted herein.

The embodiments described hereinabove are only specific embodiments of the present application, and should not be interpreted as limitation to the protection scope of the present application. Any equivalent replacements and improvements made within the principle of the present application are also fall into the protection scope of the present application.

1. A permanent magnet synchronous motor, comprising a stator and a rotor, wherein a plurality of wire slots are arranged in the stator along a circumferential direction of the stator, a plurality of magnet slot groups are arranged in the rotor along a circumferential direction of the rotor, coil are provided in each of the wire slots, and a permanent magnet is provided in each of the magnet slot groups; and wherein the number of poles of the permanent magnets in the rotor is P, a distance between two adjacent magnet slot groups is W, a tooth width of the stator is Lc, and the number of the wire slots in the stator is S, wherein a parameter K of the permanent magnet synchronous motor satisfy an expression: 3PW/LcS=K, and 0.15≦K≦0.85.

2. The permanent magnet synchronous motor according to claim 1, wherein 0.2≦K≦0.8.

3. The permanent magnet synchronous motor according to claim 1, wherein the wire slots are evenly distributed in the circumference direction of the stator and the magnet slot groups are evenly distributed in the circumference direction of the rotor.

4. The permanent magnet synchronous motor according to claim 1, wherein the magnet slot group comprises at least two magnet slots; and the magnet slots of the magnet slot group have the same orientation and are arranged in the radial direction.

5. The permanent magnet synchronous motor according to claim 1, wherein a cross section of the magnet slot is of arc-shaped or U-shaped slot, and an opening of the arc-shaped or U-shaped slot is towards a periphery of the stator in a radial direction of the magnet slot.

6. The permanent magnet synchronous motor according to claim 5, wherein clearances are respectively provided between two ends of the permanent magnet and the magnet slot.

7. The permanent magnet synchronous motor according to claim 5, wherein the permanent magnet has a flat plate structure or an arc-shaped structure.

8. The permanent magnet synchronous motor according to claim 5, wherein the permanent magnet has an arc-shaped structure, and a middle portion of the permanent magnet has a thickness greater than two ends of the permanent magnet.

9. The permanent magnet synchronous motor according to claim 2, wherein the wire slots are evenly distributed in the circumference direction of the stator and the magnet slot groups are evenly distributed in the circumference direction of the rotor.

10. The permanent magnet synchronous motor according to claim 2, wherein the magnet slot group comprises at least two magnet slots; and the magnet slots of the magnet slot group have the same orientation and are arranged in the radial direction.

11. The permanent magnet synchronous motor according to claim 2, wherein a cross section of the magnet slot is of arc-shaped or U-shaped slot, and an opening of the arc-shaped or U-shaped slot is towards a periphery of the stator in a radial direction of the magnet slot.
